(19) United States
(12) Patent Application Publication
(10) Pub. No.: US 2026/0149580 A1
(43) Pub. Date: May 28, 2026

(54) KEY SYSTEM

(71) Applicant: AISIN CORPORATION, Kariya, Aichi (JP)

(72) Inventors: Takaaki KOIZUMI, Kariya-shi (JP); Yoshihiro KUNIEDA, Kariya-shi (JP)

(73) Assignee: AISIN CORPORATION, Kariya, Aichi (JP)

(21) Appl. No.: 19/118,872

(22) PCT Filed: Oct. 11, 2023
(86) PCT No.: PCT/JP2023/036856

§ 371 Date: Apr. 7, 2025

(30) Foreign Application Priority Data
Nov. 14, 2022 (JP) 2022-181875

(51) Int. Cl. H04L 9/08

(52) U.S. Cl. CPC H04L 9/0894

(57) ABSTRACT

A key system including: a first storage part provided in a vehicle and storing identification information with which the vehicle can be identified; and a second storage part provided in a key medium and storing unique information associated with the identification information, wherein the vehicle is provided with a first determination part, a second determination part, and a common key information transmission part, and the first determination part is configured to determine whether or not an association exists between identification information stored in the first storage part and unique information stored in the second storage part.

### TECHNICAL FIELD

The present disclosure relates to a key system that performs communication between each of a vehicle and a key unit and a portable terminal.

### BACKGROUND ART

In recent years, techniques for controlling (starting or the like) a vehicle with an electronic key (also referred to as an electronic lock) via a portable terminal or the like have been used. Techniques related to such an electronic key include those described in Patent Literatures 1 and 2, for example.

Patent Literature 1 describes a car sharing system. In this car sharing system, key information is authenticated between a portable terminal in which the key information is registered in advance, as a vehicle key (corresponding to the “electronic key” described above), and a car share device mounted in a vehicle, and the vehicle can be used on the basis of the result of this authentication. When reconnection is performed between the portable terminal and the car share device, an encryption key different from an encryption key used at previous connection is used as an encryption key used between the portable terminal and the car share device.

Patent Literature 2 describes a vehicle communication system. In this vehicle communication system, different encryption keys (each corresponding to the “electronic key” described above) are used in communication between a base unit and a subordinate unit. The encryption keys are configured to be updated as needed.

### CITATIONS LIST

### Patent Literature

Patent Literature 1: JP 2019-71559 A
Patent Literature 2: JP 2007-85007 A

### SUMMARY OF DISCLOSURE

### Technical Problems

In the car sharing system described in Patent Literature 1, an encryption key different from the previous encryption key is generated each time the portable terminal and the car share device are connected to each other, and thus the management of the encryption keys becomes complicated in the portable terminal and the car share device. In addition, in the vehicle communication system described in Patent Literature 2, when communication between the base unit and the subordinate unit is intercepted at the time of sharing the encryption key, there is a possibility that the vehicle is used in an unauthorized manner.

Therefore, there is a demand for a key system in which an electronic key can be delivered in a simplified and convenient manner and that has improved security.

### Solutions to Problems

A characteristic configuration of a key system according to the present disclosure is as follows. The key system includes: a first storage part provided in a vehicle and storing identification information with which the vehicle can be identified; and a second storage part provided in a key medium and storing unique information associated with the identification information. The vehicle is provided with a first determination part, a second determination part, and a common key information transmission part. The first determination part is configured to determine whether or not an association exists between identification information stored in the first storage part and unique information stored in the second storage part. In a case where the first determination part determines that the association exists, the second determination part determines whether or not an association exists between unique information, associated with the identification information and acquired by a portable terminal from the key medium, and the identification information stored in the first storage part. In a case where the second determination part determines that the association exists, the common key information transmission part transmits common key information allowing control of the vehicle to the portable terminal.

With such a characteristic configuration, the common key information is transmitted in a case where the identification information stored in the first storage part of the vehicle and the unique information acquired by the portable terminal are associated with each other, and thus security can be improved. In addition, since the security is high, it is not necessary to change the common key information each time the portable terminal communicates with the vehicle, and thus an electronic key can be managed in a simplified and convenient manner. Further, according to the key system, instead of delivering a physical key, an electronic key (a key constructed by software) is delivered via communication, in accordance with a determination result as to whether or not the identification information stored in the first storage part of the vehicle and the unique information acquired by the portable terminal are associated with each other, and thus convenience can be improved. In this manner, the security is improved by exchanging the common key information using the three different objects, that is, the vehicle, the key medium, and the portable terminal, and the common key information is delivered to the portable terminal through the second determination part and the common key information transmission part, and thus the electronic key can be delivered in a simplified and convenient manner.

Further, another characteristic configuration of the key system according to the present disclosure is as follows. The key system includes: a first storage part provided in a vehicle and storing identification information with which the vehicle can be identified; and a second storage part provided in a key medium and storing unique information associated with the identification information. The vehicle is provided with a first determination part, a second determination part, and a common key information transmission part. The first determination part is configured to determine whether or not an association exists between identification information stored in the first storage part and unique information stored in the second storage part. In a case where the first determination part determines that the association exists, the second determination part determines whether or not an association exists between identification information, with which the vehicle can be identified, acquired by a portable terminal from the vehicle, and the identification information stored in the first storage part. In a case where the second determination part determines that the association exists, the common key information transmission part transmits common key information allowing control of the vehicle to the portable terminal.

With such a characteristic configuration, the common key information is transmitted in a case where the identification information stored in the first storage part of the vehicle and the identification information, with which the vehicle can be identified, acquired by the portable terminal are associated with each other, and thus security can be improved. In addition, also with this characteristic configuration, since the security is high, it is not necessary to change the common key information each time the portable terminal communicates with the vehicle, and thus an electronic key can be managed in a simplified and convenient manner. Further, also in the key system of this characteristic configuration, instead of delivering a physical key, an electronic key (a key constructed by software) is delivered via communication, in accordance with a determination result as to whether or not the identification information stored in the first storage part of the vehicle and the identification information, with which the vehicle can be identified, acquired by the portable terminal are associated with each other, and thus convenience can be improved. In this manner, the security is improved by exchanging the common key information using the three different objects, that is, the vehicle, the key medium, and the portable terminal, and the common key information is delivered to the portable terminal through the second determination part and the common key information transmission part, and thus the electronic key can be delivered in a simplified and convenient manner.

### BRIEF DESCRIPTION OF DRAWINGS

FIG. 1 is a block diagram showing a configuration of a key system.

FIG. 2 is an explanatory diagram of delivery of unique information from a key medium to a portable terminal.

FIG. 3 is an explanatory diagram of delivery of keys between a vehicle and the portable terminal.

FIG. 4 is an explanatory diagram of delivery of keys between the vehicle and the portable terminal.

FIG. 5 is an explanatory diagram of delivery of keys between the portable terminal and another portable terminal.

### DESCRIPTION OF EMBODIMENTS

A key system according to the present disclosure is configured such that an electronic key allowing control of a vehicle is delivered between the vehicle and a portable terminal. Hereinafter, a key system 1 of the present embodiment will be described.

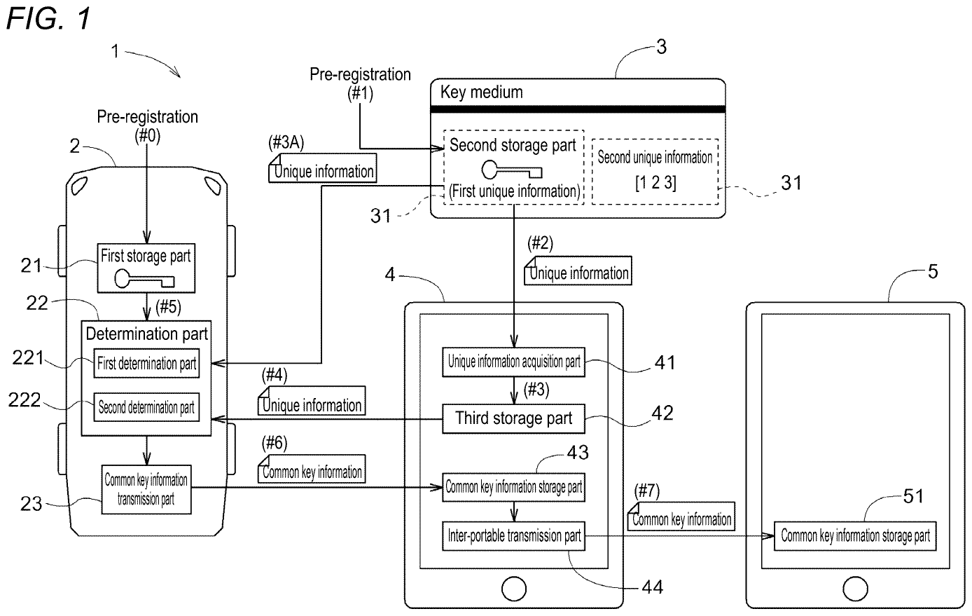

FIG. 1 is a block diagram schematically showing a configuration of the key system 1. As shown in FIG. 1, in the present embodiment, the key system 1 performs communication between each of a vehicle 2 and a key medium 3 and a portable terminal 4 to deliver an electronic key. In the present embodiment, the vehicle 2 is provided with a first storage part 21, a determination part 22, and a common key information transmission part 23, and the key medium 3 is provided with a second storage part 31. In addition, the portable terminal 4 is provided with a unique information acquisition part 41, a third storage part 42, a common key information storage part 43, and an inter-portable transmission part 44. In the present embodiment, the portable terminal 4 is configured to be able to communicate with another portable terminal 5 (corresponding to “another portable terminal” or “the other portable terminal”), and the portable terminal S is provided with a common key information storage part 51. Each functional part is constructed by hardware, software, or both, with a CPU as a core component, in order to perform processing related to delivery of an electronic key.

The first storage part 21 stores identification information with which the vehicle 2 can be identified. The identification information with which the vehicle 2 can be identified is, for example, information with which one vehicle 2 can be identified (determined) from among a plurality of vehicles 2. Such identification information can be constructed by combining, for example, a plurality of alphanumeric characters or symbols (hereinafter, “alphanumeric characters or the like”). In this case, the identification information includes two or more alphanumeric characters or the like. Such identification information is pre-registered at a production factory or a dealer (hereinafter referred to as a “production factory or the like”) of the vehicle 2 (#0).

That is, at the production factory, the registration can be performed at the time of producing the vehicle 2, or at the dealer, the registration can be performed after the vehicle 2 is shipped, or the identification information may be updated each time the vehicle 2 and the key medium 3 communicate with each other.

As described above, the second storage part 31 is provided in the key medium 3, and the key medium 3 is associated with the vehicle 2. A state in which the key medium 3 is associated with the vehicle 2 means a state in which the vehicle 2 and the key medium 3 are associated in a one-to-one correspondence. In the present embodiment, the second storage part 31 stores unique information associated with the identification information stored in the first storage part 21. The unique information may be information including alphanumeric characters or the like that are the same as those of the identification information, or may be constructed by further combining at least one character or the like among alphanumeric characters or the like with the identification information. In the present embodiment, the unique information will be described as information including the same alphanumeric characters or the like as those of the identification information. Therefore, hereinafter, the unique information may be referred to as identification information, and the identification information may be referred to as unique information. The storage of the unique information in the second storage part 31 is performed by pre-registering the unique information at the production factory or the like of the vehicle 2, similarly to the storage of the identification information in the first storage part 21 of the vehicle 2 (#1). The key medium 3 is formed of an IC card from which the portable terminal 4 can acquire the unique information stored in the second storage part 31 via, for example, short-range wireless communication. Therefore, the key medium 3 is not limited to the size as shown in FIG. 1, and may be, for example, a size based on “ID-1”, which is an international standard.

The unique information acquisition part 41 acquires the unique information from the second storage part 31 (#2). In the present embodiment, as described above, the key medium 3 is an IC card, and the unique information stored in the second storage part 31 can be acquired by the portable terminal 4 via short-range wireless communication. Therefore, the unique information acquisition part 41 acquires the unique information from the second storage part 31 via short-range wireless communication.

In the present embodiment, the unique information includes first unique information and second unique information. The first unique information is information acquirable by the portable terminal 4 via communication. Being acquirable by the portable terminal 4 via communication means that the portable terminal 4 can perform the acquiring via short-range wireless communication. On the other hand, the second unique information is information shown on the key medium 3. In the present embodiment, the key medium 3 is an IC card. Therefore, the second unique information is shown on the IC card. In the example of FIG. 1, the first unique information is stored in the second storage part 31, and “123” that are the second unique information is shown on the IC card. Of course, the second card information may be alphanumeric characters or the like other than “123”. In addition, the number of characters or the like may be 4 or more or 2 or less. The second unique information may be shown on another medium, instead of being shown on the key medium 3.

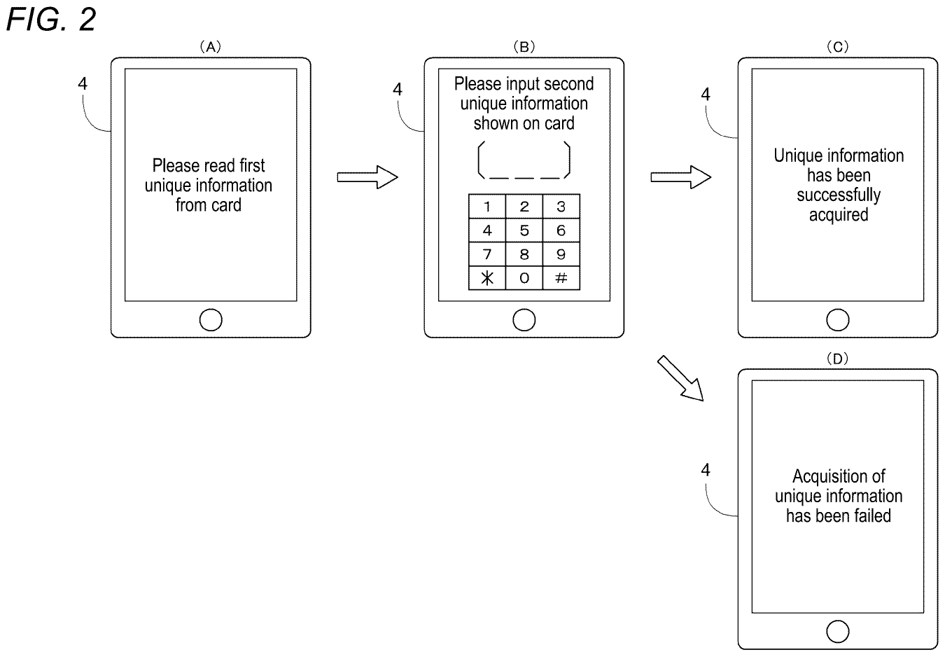

In such a case, the unique information acquisition part 41 acquires the unique information on the basis of the acquisition of the first unique information via communication and the input of the second unique information to the portable terminal 4. That is, when the unique information acquisition part 41 acquires the unique information, for example, a launch is preferably performed at the portable terminal 4 by an application related to the key system 1, and a message requesting reading of the first unique information from the IC card is preferably displayed on the portable terminal 4, as shown in FIG. 2A. When the portable terminal 4 has read the first unique information, a message requesting input of the second unique information shown on the IC card is preferably displayed on the portable terminal 4, as shown in FIG. 2B. When the second unique information has been input and the unique information has been appropriately acquired by combining the read first unique information and the second unique information, the unique information acquisition part 41 is preferably displays a message indicating that the unique information has been successfully acquired, as shown in FIG. 2C. When the second unique information has not been appropriately input or when the appropriate unique information has not been acquired even by combining the read first unique information and the second unique information, the unique information acquisition part 41 is preferably displays a message indicating that acquisition of the unique information has been failed, as shown in FIG. 2D.

Returning to FIG. 1, the third storage part 42 stores the unique information acquired by the unique information acquisition part 41 (#3). As described above, in a case where the unique information includes the first unique information and the second unique information, a configuration is preferably made such that the first unique information and the second unique information are preferably stored separately in the third storage part 42. Alternatively, a configuration may be made such that unique information obtained by combining the first unique information and the second unique information is stored.

The determination part 22 includes a first determination part 221 and a second determination part 222. The first determination part 221 determines whether or not the identification information stored in the first storage part 21 and the unique information stored in the second storage part 31 are associated with each other. In the present embodiment, the first storage part 21 is provided in the vehicle 2, and the second storage part 31 is provided in the key medium 3. The determination made by the first determination part 221 is performed by reading, through the vehicle 2, the unique information stored in the key medium 3 (#3A). In the present embodiment, the identification information and the unique information are identical to each other. Therefore, the first determination part 221 determines whether or not the unique information acquired from the key medium 3 matches the identification information stored in the first storage part 21. Here, in a case where the unique information is constructed by combining a plurality of alphanumeric characters or symbols as described above, it is determined not only whether or not the alphanumeric characters or symbols match, but also whether or not the arrangement orders of the alphanumeric characters or the symbols match. The determination result obtained by the first determination part 221 is transmitted to the second determination part 222.

In a case where the first determination part 221 determines that the identification information and the unique information are associated with each other, the second determination part 222 determines whether or not the unique information acquired by the portable terminal 4 from the second storage part 31 and the identification information stored in the first storage part 21 are associated with each other. In the present embodiment, as described above, the unique information acquired by the unique information acquisition part 41 is stored in the third storage part 42. Therefore, the second determination part 222 acquires the unique information from the third storage part 42 (#4), and determines whether or not the acquired unique information is associated with the identification information stored in the first storage part 21 (#5). In the present embodiment, the identification information and the unique information are identical to each other. Therefore, the second determination part 222 determines whether or not the unique information acquired from the third storage part 42 matches the identification information stored in the first storage part 21. Also here, in a case where the unique information is constructed by combining a plurality of alphanumeric characters or symbols as described above, it is determined not only whether or not the alphanumeric characters or symbols match, but also whether or not the arrangement orders of the alphanumeric characters or the symbols match. The determination result obtained by the second determination part 222 is transmitted to the common key information transmission part 23. On the basis of the determination result of the second determination part 222, the portable terminal 4 to which common key information of the vehicle 2 can be transmitted is authenticated.

As described above, in a case where the unique information includes the first unique information and the second unique information, the second determination part 222 preferably determines whether or not the unique information is associated with the identification information on the basis of the first unique information and the second unique information.

In a case where the second determination part 222 determines that the unique information is associated with the identification information, the common key information transmission part 23 transmits common key information allowing control of the vehicle 2 to the portable terminal 4 (#6). In the present embodiment, the identification information stored in the first storage part 21 and the unique information stored in the second storage part 31 are identical to each other. Therefore, in a case where it is determined that the unique information acquired from the third storage part 42 matches the identification information stored in the first storage part 21, the common key information transmission part 23 transmits the common key information allowing control of the vehicle 2 to the portable terminal 4. The common key information transmission part 23 determines whether or not the unique information acquired from the third storage part 42 by the second determination part 222 has been determined to match the identification information stored in the first storage part 21, on the basis of the determination result transmitted from the second determination part 222. Allowing control of the vehicle 2 means allowing electric components of the vehicle 2 to be energized, and/or allowing an engine to start combustion (or allowing the vehicle 2 to start traveling by using a battery). Therefore, allowing control of the vehicle 2 means allowing the electric components or the engine of the vehicle 2 to start (or allowing a traveling motor to be driven by using the battery). When the determination result indicating that the unique information acquired from the third storage part 42 matches the identification information stored in the first storage part 21 is transmitted from the second determination part 222, the common key information transmission part 23 transmits, to the portable terminal 4, the common key information allowing the electric components or the engine of the vehicle 2 to start (or allowing the traveling motor to be driven by using the battery). The communication between the common key information transmission part 23 and the portable terminal 4 related to the transmission of the common key information may be performed via a network, or may be performed via short-range wireless communication.

The common key information storage part 43 stores the common key information transmitted from the common key information transmission part 23. A user of the portable terminal 4 can use the vehicle 2 by using a common key corresponding to the common key information stored in the common key information storage part 43.

In addition, in the present embodiment, the inter-portable transmission part 44 of the portable terminal 4 is configured to be able to transmit the transmitted common key information to the other portable terminal 5 different from the portable terminal 4. When the common key information is transmitted to the other portable terminal 5, a common key information sending part 24 sends the common key information to the other portable terminal S via, for example, a mail or a network (#7). Of course, the sending can also be performed via short-range wireless communication.

In the portable terminal 5, the common key information storage part 51 stores the common key information sent from the common key information sending part 24. Accordingly, not only the user of the portable terminal 4 but also a user of the portable terminal 5 can use the vehicle 2. Note that, for example, in a case where the user of the portable terminal 4 and the user of the portable terminal 5 are family members, or in a case where restriction on use of key information is not particularly set, the common key information stored in the third storage part 42 need not be deleted even if the common key information is transmitted from the portable terminal 4 to the portable terminal 5. On the other hand, in a case where restriction on use of key information is set, such as a case where the vehicle 2 is used by car sharing, a configuration is preferably made such that the common key information stored in the third storage part 42 is deleted when the common key information is transmitted from the portable terminal 4 to the portable terminal 5. In addition, it is also possible to set a validity period for the common key information stored in the common key information storage part 51 of the portable terminal 5, and invalidate the common key information stored in the common key information storage part 51 of the portable terminal 5 when the validity period expires. Thus, security can be enhanced.

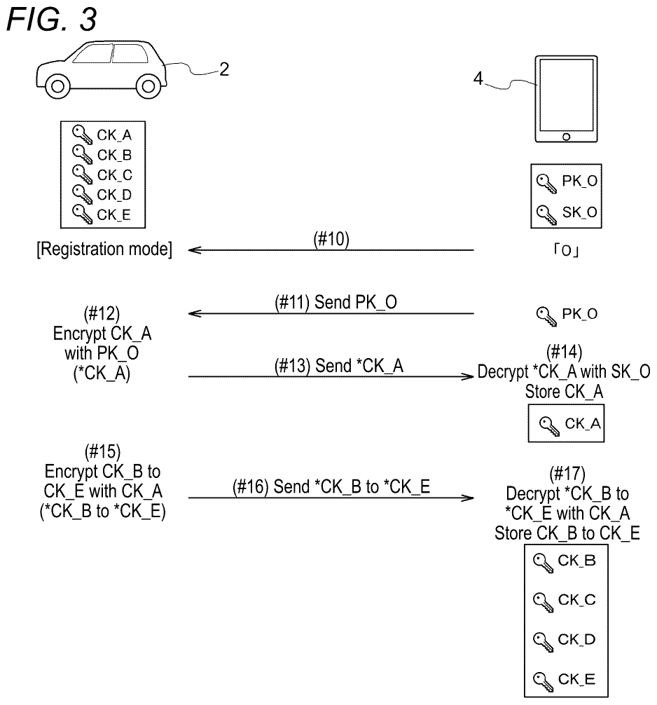

Here, the transmission of the common key information between the vehicle 2 and the portable terminal 4 is performed with encryption of the common key information. Such transmission of common key information with encryption will be described with reference to FIG. 3. Note that, here, description regarding authentication of the portable terminal 4 performed by the vehicle 2 on the basis of the unique information, which is performed before the common key information is transmitted, will be omitted.

In the example of FIG. 3, five common keys (common key information) are stored in the vehicle 2. Specifically, five common keys “CK_A”, “CK_B”, “CK_C”, “CK_D” and “CK_E” are stored in the vehicle 2. The common keys “CK_A” and “CK_B” are common keys for which no validity period is set for the vehicle 2, the common keys “CK_C” and “CK_D” are common keys for which a validity period is set for the vehicle 2 (for example, valid only for 24 hours), and the common key “CK_E” is a common key allowing only entry into the vehicle cabin of the vehicle 2 (allowing only release of the door lock). In addition, the portable terminal 4 stores “PK_O” as a public key and “SK_O” as a private key.

When the portable terminal 4 acquires common keys from the vehicle 2, first, the public key “PK_O” is registered from the portable terminal 4 to the vehicle 2. Therefore, in order to shift the vehicle 2 (the state of the vehicle 2) to a registration mode in which the public key “PK_O” can be registered, a predetermined command (“0” in the example of FIG. 3) for shifting the vehicle 2 to the registration mode is sent from the portable terminal 4 to the vehicle 2 (#10). As a result, the vehicle 2 enters the registration mode.

In a state where the vehicle 2 is in the registration mode, “PK_O” stored as a public key is further sent from the portable terminal 4 (#11). In the vehicle 2, upon reception of the public key “PK_O”, the common key “CK_A” is encrypted with the public key “PK_O” (#12). Here, the encrypted common key “CK_A” is set as “*CK_A”. “*CK_A” is sent from the vehicle 2 to the portable terminal 4 (#13).

Upon receiving “*CK_A”, the portable terminal 4 decrypts “*CK_A” with the private key “SK_O”, and the decrypted “CK_A” is stored in the portable terminal 4 (#14). Subsequently, in the vehicle 2, four common keys “CK_B”, “CK_C”, “CK_D”, and “CK_E” are encrypted with the common key “CK_A” (#15). The respective encrypted common keys are set as “*CK_B”, “*CK_C”, “*CK_D”, and “*CK_E”. “*CK_B”, “*CK_C”, “*CK_D”, and “*CK_E” are collectively sent from the vehicle 2 to the portable terminal 4 (#16).

Upon receiving “*CK_B”, “*CK_C”, “*CK_D”, and “*CK_E”, the portable terminal 4 decrypts “*CK_B”, “*CK_C”, “*CK_D”, and “*CK_E” with the previously acquired common key “CK_A”, and the decrypted “CK_B”, “CK_C”, “CK_D”, and “CK_E” are stored in the portable terminal 4 (#17).

In this manner, the common key information transmission part 23 encrypts the common key information (in this example, “CK_B”, “CK_C”, “CK_D”, and “CK_E”) with the common encryption key (in this example, “CK_A”) preset between the vehicle 2 and the portable terminal 4, and performs transmission to the portable terminal 4. Then, the encrypted common keys are decrypted with the previously transmitted common key in the portable terminal 4. Thus, the portable terminal 4 can acquire a common key stored in the vehicle 2.

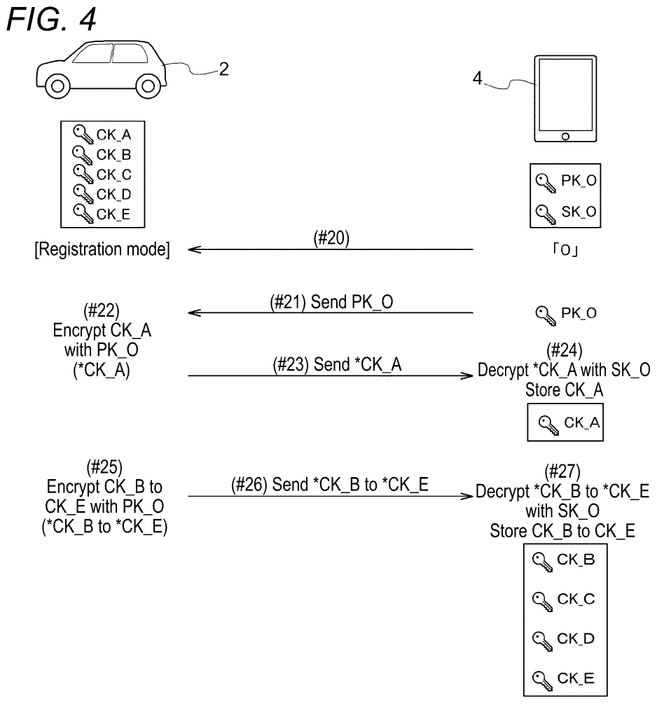

In the example of FIG. 3, a configuration is made such that the common key is encrypted with the common key information. However, a configuration can be made such that the common key is encrypted with a public key (public key information) and is transmitted. Such transmission of common key information with encryption with a public key will be described with reference to FIG. 4. Note that, also here, description regarding authentication of the portable terminal 4 performed by the vehicle 2 on the basis of the unique information (determination made by the first determination part 221, or determination made by the second determination part 222), which is performed before the common key information is transmitted, will be omitted.

In the example of FIG. 4, five common keys (common key information) are stored in the vehicle 2. Specifically, five common keys “CK_A”, “CK_B”, “CK_C”, “CK_D”, and “CK_E” are stored in the vehicle 2. The common keys “CK_A” and “CK_B” are common keys for which no validity period is set for the vehicle 2, the common keys “CK_C” and “CK_D” are common keys for which a validity period is set for the vehicle 2 (for example, valid only for 24 hours), and the common key “CK_E” is a common key allowing only entry into the vehicle cabin of the vehicle 2 (allowing only release of the door lock). In addition, the portable terminal 4 stores “PK_O” as a public key and “SK_O” as a private key.

When the portable terminal 4 acquires common keys from the vehicle 2, first, the public key “PK_O” is registered from the portable terminal 4 to the vehicle 2. Therefore, in order to shift the vehicle 2 (the state of the vehicle 2) to a registration mode in which the public key “PK_O” can be registered, a predetermined command (“0” in the example of FIG. 4) for shifting the vehicle 2 to the registration mode is sent from the portable terminal 4 to the vehicle 2 (#20). As a result, the vehicle 2 enters the registration mode.

In a state where the vehicle 2 is in the registration mode, “PK_O” stored as a public key is further sent from the portable terminal 4 (#21). In the vehicle 2, upon reception of the public key “PK_O”, the common key “CK_A” is encrypted with the public key “PK_O” (#22). Here, the encrypted common key “CK_A” is set as “*CK_A”. “*CK_A” is sent from the vehicle 2 to the portable terminal 4 (#23).

Upon receiving “*CK_A”, the portable terminal 4 decrypts “*CK_A” with the private key “SK_O”, and the decrypted “CK_A” is stored in the portable terminal 4 (#24). Subsequently, in the vehicle 2, four common keys “CK_B”, “CK_C”, “CK_D”, and “CK_E” are encrypted with the public key “PK_O” (#25). The respective encrypted common keys are set as “*CK_B”, “*CK_C”, “*CK_D”, and “*CK_E”. “*CK_B”, “*CK_C”, “*CK_D”, and “*CK_E” are collectively sent from the vehicle 2 to the portable terminal 4 (#26).

Upon receiving “*CK_B”, “*CK_C”, “*CK_D”, and “*CK_E”, the portable terminal 4 decrypts “*CK_B”, “*CK_C”, “*CK_D”, and “*CK_E” with the private key “SK_O”, and the decrypted “CK_B”, “CK_C”, “CK_D”, and “CK_E” are stored in the portable terminal 4 (#27).

In this manner, the common key information transmission part 23 encrypts the common key information (in this example, “CK_B”, “CK_C”, “CK_D”, and “CK_E”) with the public key (in this example, “PK_O”) preset between the vehicle 2 and the portable terminal 4. Then, the encrypted common keys are decrypted with the private key already stored in the portable terminal 4. Thus, the portable terminal 4 can acquire a common key stored in the vehicle 2, in a high-security state.

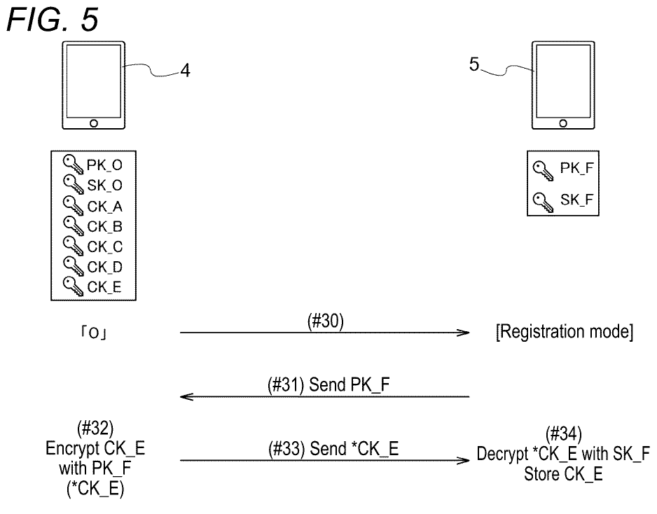

Next, transmission of a common key (common key information) to the other portable terminal 5 performed by the portable terminal 4 will be described with reference to FIG. 5.

In the example of FIG. 5, the portable terminal 4 stores a public key (public key information) “PK_O”, a private key (private key information) “SK_O”, and five common keys (common key information). Specifically, five common keys “CK_A”, “CK_B”, “CK_C”, “CK_D”, and “CK_E” are stored in the vehicle 2. The common keys “CK_A” and “CK_B” are common keys for which no validity period is set for the vehicle 2, the common keys “CK_C” and “CK_D” are common keys for which a validity period is set for the vehicle 2 (for example, valid only for 24 hours), and the common key “CK_E” is a common key allowing only entry into the vehicle cabin of the vehicle 2 (allowing only release of the door lock). In the example of FIG. 5, an example is shown in which only “CK_E” is transmitted to the portable terminal 5. In addition, the portable terminal 5 stores “PK_F” as a public key and “SK_F” as a private key.

When the portable terminal 4 registers the common key “CK_E” in the portable terminal 5, first, the portable terminal 5 (the state of the portable terminal 5) needs to be in a registration mode in which the common key “CK_E” can be registered. Therefore, in order to shift the portable terminal 5 (the state of the portable terminal 5) to the registration mode, a predetermined command (“0” in the example of FIG. 5) for shifting the portable terminal 5 to the registration mode is sent from the portable terminal 4 to the portable terminal 5 (#30). As a result, the portable terminal 5 enters the registration mode.

When the portable terminal 5 enters the registration mode, the portable terminal 5 sends “PK_F” stored as a public key to the portable terminal 4 (#31). In the portable terminal 4, upon reception of the public key “PK_F”, the common key “CK_E” is encrypted with the public key “PK_F” (#32). Here, the encrypted common key “CK_E” is set as “*CK_E”. “*CK_. E” is sent from the portable terminal 4 to the portable terminal 5 (#33).

Upon receiving “*CK_E”, the portable terminal 5 decrypts “*CK_E” with the private key “SK_F”, and the decrypted “CK_E” is stored in the portable terminal 5 (#34).

In this manner, when the common key is transmitted from the portable terminal 4 to the portable terminal 5, the public key (in this example, “PK_F”) is transmitted from the portable terminal 5 to the portable terminal 4, the common key “CK_E” is encrypted with the public key “PK_F”, and the encrypted common key is decrypted with the private key “SK_F” already stored in the portable terminal 5. Thus, the portable terminal 4 can appropriately transmit the common key to the portable terminal

### Other Embodiments

In the above embodiment, it has been described that the common key information is transmitted between the vehicle 2 and the portable terminal 4 via short-range wireless communication, and that the common key information is transmitted between the portable terminal 4 and the portable terminal 5 via a mail or a network. For example, in a case where the vehicle 2 includes a communication device that can perform communication via a network, a configuration can also be made such that communication between the vehicle 2 and the portable terminal 4 is performed via a server accessible by each of the vehicle 2 and the portable terminal 4, instead of or in addition to the short-range wireless communication. In this case, communication between the portable terminal 4 and the portable terminal 5 can also be performed via the server.

In addition, in a case where the vehicle 2 does not include the communication device that can perform communication via a network, a configuration can also be made such that communication between the vehicle 2 and the portable terminal 4 is performed via short-range wireless communication as in the above embodiment, and such that communication between the portable terminal 4 and the portable terminal 5 is performed via a server.

In the above embodiment, it has been described that the identification information stored in the first storage part 21 and the unique information stored in the second storage part 31 are identical to each other. However, the identification information stored in the first storage part 21 and the unique information stored in the second storage part 31 may be different from each other. In this case, for example, the identification information and the unique information can be constructed to be partially common to each other. Alternatively, for example, the unique information may be generated on the basis of the identification information.

In the above embodiment, it has been described that the key medium 3 is an IC card. However, the key medium 3 may be a smart key that locks and unlocks the door lock of the vehicle 2.

In the above embodiment, it has been described that the portable terminal 4 can transmit the common key information to the portable terminal 5. However, the portable terminal 4 can be configured to be unable to transmit the common key information to the portable terminal 5. In this case, the portable terminal 4 need not be provided with the inter-portable transmission part 44.

In the above embodiment, it has been described that the common key information transmission part 23 encrypts the common key information with the common encryption key preset between the vehicle 2 and the portable terminal 4 and transmits it to the portable terminal 4. The common key information transmission part 23 can also be configured to transmit a plurality of pieces of the common key information to the portable terminal 4, and among the plurality of pieces of the common key information, one piece of the plurality pieces of the common key information to be transmitted first to the portable terminal 4 is encrypted with the common encryption key preset between the vehicle 2 and the portable terminal 4, and the other pieces of the plurality of the common key information to be transmitted subsequently are encrypted on the basis of respective pieces of the plurality of pieces of the common key information transmitted immediately previously.

Specifically, in the case of the example shown in FIG. 3, when the plurality of common keys “CK_A”, “CK_B”, “CK_C”, “CK_D”, and “CK_E” are transmitted from the vehicle 2 to the portable terminal 4, preferably, the common key “CK_A” to be transmitted first is encrypted with “PK_O”, which is a preset common encryption key, and is transmitted from the vehicle 2 to the portable terminal 4, the common key “CK_B” to be transmitted next is encrypted with “CK_A” transmitted immediately previously, the common key “CK_C” to be transmitted next is encrypted with “CK_B” transmitted immediately previously, the common key “CK_D” to be transmitted next is encrypted with “CK_C” transmitted immediately previously, and the common key “CK_E” to be transmitted next is encrypted with “CK_D” transmitted immediately previously. Even with such a configuration, it is possible to appropriately transmit the common keys from the vehicle 2 to the portable terminal 4.

In such a case, only when the first piece of the common key information can be appropriately acquired, the next piece of the common key information can be acquired. In addition, the plurality of pieces of common key information are encrypted with respective different pieces of unique common key information, and thus security can be further improved. Further, on the portable terminal 4 side, common key information transmitted earlier serves as a decryption key for decryption, and thus it is not necessary to store a decryption key in advance. Therefore, the risk that a decryption key is stolen can be reduced, and thus security can be improved also in this respect.

In the above embodiment, it has been described that the unique information includes the first unique information and the second unique information. However, the unique information may include only a single piece of unique information. Alternatively, the unique information may further include third unique information in addition to the first unique information and the second unique information. In this case, the third unique information may be acquired from the vehicle 2, for example, or may be information shown on the vehicle 2 (for example, a registration number or the like).

In the above embodiment, it has been described that the common keys “CK_A” and “CK_B” are common keys for which no validity period is set for the vehicle 2, the common keys “CK_C” and “CK_D” are common keys for which a validity period is set for the vehicle 2 (for example, valid only for 24 hours), and the common key “CK_E” is a common key allowing only entry into the vehicle cabin of the vehicle 2 (allowing only release of the door lock). However, for example, a common key having such a function that allows a courier to only unlock the trunk of the vehicle 2 is set, whereby a recipient-absent delivery package can be received by causing the delivery package to be stored in the vehicle 2. In addition, for example, in a case where the common key information is passed to a user who is unfamiliar with driving operation, a configuration may be made such that common key information on which a speed limit is imposed is transmitted.

In the above embodiment, while using, as an example, a configuration in which the key system 1 performs communication between each of the vehicle 2 and the key medium 3 and the portable terminal 4, it has been described that the first determination part 221 determines whether or not the identification information stored in the first storage part 21 and the unique information stored in the second storage part 31 are associated with each other, and that the second determination part 222 determines, in a case where the first determination part 221 determines that the association exists, whether or not the unique information, associated with the identification information and acquired by the portable terminal 4, and the identification information stored in the first storage part 21 are associated with each other. In this case, a configuration is made such that the unique information stored in the key medium 3 is read by the vehicle 2 and the unique information stored in the key medium 3 is read by the portable terminal 4. Alternatively, a configuration can be made such that the unique information stored in the key medium 3 is read by the vehicle 2 and the unique information stored in the portable terminal 4 is read by causing the portable terminal 4 to be held over the vehicle 2.

In this case, preferably, the key system 1 is configured to perform communication between each of the key medium 3 and the portable terminal 4 and the vehicle 2, and one that can communicate with the vehicle 2 (for example, an IC card) is adopted as the key medium 3, and the key medium 3 and the vehicle 2 are associated with each other.

Such a key system 1 is configured to include: a first storage part 21 provided in a vehicle 2 and storing identification information with which the vehicle 2 can be identified; a second storage part 31 provided in a key medium 3 and storing unique information associated with the identification information; a first determination part 221 configured to determine whether or not an association exists between the identification information stored in the first storage part 21 and the unique information stored in the second storage part 31; a second determination part 222 configured to determine, in a case where the first determination part 221 determines that the association exists, whether or not an association exists between identification information, with which the vehicle 2 can be identified, acquired by a portable terminal 4, and the identification information stored in the first storage part 21; and a common key information transmission part 23 configured to transmit, in a case where the second determination part 222 determines that the association exists, common key information allowing control of the vehicle 2 to the portable terminal 4.

In such a key system 1, preferably, the first storage part 21, the second storage part 31, and the first determination part 221 are configured similarly to those in the above embodiment, a shift is made to a registration mode in which a user can be registered, upon communication between the key medium 3 and the vehicle 2 as a trigger, and the vehicle 2 and the portable terminal 4 are associated with each other via short-range wireless communication. This association is preferably performed, for example, by transmitting one-time key information from the vehicle 2 to the portable terminal 4 via short-range wireless communication, and causing the common key information transmission part 23 to transmit common key information to the portable terminal 4 on the basis of the one-time key information transmitted to the portable terminal 4. Note that this transmission of the common key information may be made by delivery through a public key cryptosystem.

In addition to the configurations in the above embodiment, the key system 1 can also be configured as follows.

(1) When communication is performed between the vehicle 2 and the portable terminal 4, a linkage may be made with personal information of a user of the portable terminal 4.

(2) When communication is performed between the vehicle 2 and the portable terminal 4, the communication may be performed after the portable terminal 4 is registered together with a device (for example, a car navigation device) having another function or application. Thus, the operation can be performed via the car navigation device, and thus visibility and operability are enhanced and convenience can be improved.

(3) When the portable terminal 4 acquires common key information from the vehicle 2, unique information acquired by the portable terminal 4 may be deleted.

(4) A configuration may be made such that common key information can be delivered after a screen operation on a car navigation device mounted in the vehicle 2 is performed in advance of communication between the vehicle 2 and the portable terminal 4.

(5) In a case where a functional restriction or a validity period is given to common key information, a configuration may be made such that the vehicle 2 automatically invalidates the target common key information when the validity period expires. Alternatively, a configuration may be made such that such invalidation of common key information is performed by the portable terminal 4.

(6) The prescribed number of times may be set for common key information, and common keys without duplication may be generated within the prescribed number of times.

(7) A configuration may be made such that communication between the vehicle 2 and the portable terminal 4 is performed after two-step authentication. Thus, security can be enhanced.

### Outlines of Above Embodiments

Outlines of the key system 1 described above will be described below.

(1) A key system 1 includes: a first storage part 21 provided in a vehicle 2 and storing identification information with which the vehicle 2 can be identified; and a second storage part 31 provided in a key medium 3 and storing unique information associated with the identification information. The vehicle 2 is provided with a first determination part 221, a second determination part 222, and a common key information transmission part 23. The first determination part 221 is configured to determine whether or not an association exists between identification information stored in the first storage part 21 and unique information stored in the second storage part 31. In a case where the first determination part 221 determines that the association exists, the second determination part 222 determines whether or not an association exists between unique information, associated with the identification information and acquired by a portable terminal 4 from the key medium 3, and the identification information stored in the first storage part 21. In a case where the second determination part 222 determines that the association exists, the common key information transmission part 23 transmits common key information allowing control of the vehicle 2 to the portable terminal 4.

According to this configuration, the common key information is transmitted in a case where the identification information stored in the first storage part 21 of the vehicle 2 and the unique information acquired by the portable terminal 4 are associated with each other, and thus security can be improved. In addition, since the security is high, it is not necessary to change the common key information each time the portable terminal 4 communicates with the vehicle 2, and thus an electronic key can be managed in a simplified and convenient manner. Further, according to the key system 1, instead of delivering a physical key, an electronic key (a key constructed by software) is delivered via communication, in accordance with a determination result as to whether or not the identification information stored in the first storage part 21 of the vehicle 2 and the unique information acquired by the portable terminal 4 are associated with each other, and thus convenience can be improved. In this manner, the security is improved by exchanging the common key information using the three different objects, that is, the vehicle 2, the key medium 3, and the portable terminal 4, and the common key information is delivered to the portable terminal 4 through the second determination part 222 and the common key information transmission part 23, and thus the electronic key can be delivered in a simplified and convenient manner.

(2) A key system 1 includes: a first storage part 21 provided in a vehicle 2 and storing identification information with which the vehicle 2 can be identified; and a second storage part 31 provided in a key medium 3 and storing unique information associated with the identification information. The vehicle 2 is provided with a first determination part 221, a second determination part 222, and a common key information transmission part 23. The first determination part 221 is configured to determine whether or not an association exists between identification information stored in the first storage part 21 and unique information stored in the second storage part 31. In a case where the first determination part 221 determines that the association exists, the second determination part 222 determines whether or not an association exists between identification information, with which the vehicle 2 can be identified, acquired by a portable terminal 4 from the vehicle 2, and the identification information stored in the first storage part 21. In a case where the second determination part 222 determines that the association exists, the common key information transmission part 23 transmits common key information allowing control of the vehicle 2 to the portable terminal 4.

According to this configuration, the common key information is transmitted in a case where the identification information stored in the first storage part 21 of the vehicle 2 and the identification information, with which the vehicle 2 can be identified, acquired by the portable terminal 4 are associated with each other, and thus security can be improved. In addition, also in this characteristic configuration, since the security is high, it is not necessary to change the common key information each time the portable terminal 4 communicates with the vehicle 2, and thus an electronic key can be managed in a simplified and convenient manner. Further, also in the key system 1 of this characteristic configuration, instead of delivering a physical key, an electronic key (a key constructed by software) is delivered via communication, in accordance with a determination result as to whether or not the identification information stored in the first storage part 21 of the vehicle 2 and the identification information, with which the vehicle 2 can be identified, acquired by the portable terminal 4 are associated with each other, and thus convenience can be improved. In this manner, the security is improved by exchanging the common key information using the three different objects, that is, the vehicle 2, the key medium 3, and the portable terminal 4, and the common key information is delivered to the portable terminal 4 through the second determination part 222 and the common key information transmission part 23, and thus the electronic key can be delivered in a simplified and convenient manner.

(3) Preferably, the key system 1 described in (2) is configured to perform communication between the key medium 3 and the vehicle 2, and is configured such that the unique information stored in the key medium 3 is read by the vehicle 2.

According to this configuration, the unique information stored in the key medium 3 can be delivered between the vehicle 2 and the key medium 3 in a simplified and convenient manner.

(4) Preferably, the key system 1 described in (1) to (3) further includes an inter-portable transmission part 44 configured to allow the portable terminal 4 to transmit, to another portable terminal 5 different from the portable terminal 4, the common key information that has been transmitted.

According to this configuration, it is possible to share the common key information with a plurality of users, in a simplified and convenient manner. In addition, since the common key information can be shared between the portable terminal 4 and the other portable terminal 5 using, for example, short-range wireless communication instead of being via a server, it is not necessary to spend the maintenance cost and the management cost of the server, and it is possible to reduce the cost of the key system 1.

(5) In the key system 1 described in (1) to (3), preferably, the common key information transmission part 23 is configured to encrypt the common key information with a common encryption key preset between the vehicle 2 and the portable terminal 4, and transmit the common key information to the portable terminal 4.

According to this configuration, the security can be further improved, for example, by setting the encryption key to be complex. In addition, since the common encryption key is known only to limited users, it is not necessary to change the encryption key each time, unlike the conventional cases of encryption with publicly shared encryption keys.

(6) In the key system 1 described in (1) to (3), preferably, the common key information transmission part 23 is configured to transmit a plurality of pieces of the common key information to the portable terminal 4, and among the plurality of pieces of the common key information, one piece of the common key information to be transmitted first to the portable terminal 4 is encrypted with a common encryption key preset between the vehicle 2 and the portable terminal 4, and another piece of the common key information to be transmitted subsequently is encrypted based on one piece of the common key information transmitted immediately previously.

According to this configuration, only when the portable terminal 4 can appropriately acquire the first piece of common key information, the next piece of common key information can be acquired. In addition, the plurality of pieces of common key information are encrypted with respective different pieces of unique common key information. Thus, security can be further improved. Further, on the portable terminal 4 side, common key information transmitted earlier serves as a decryption key for decrypting common key information transmitted next, and thus it is not necessary to store a decryption key in advance. Therefore, the risk that a decryption key is stolen can be reduced, and thus security can be improved also in this respect.

(7) In the key system 1 described in (1) to (3), preferably, the unique information includes first unique information acquirable by the portable terminal 4 via communication and second unique information shown on the key medium 3, and the second determination part 222 is configured to determine, based on the first unique information, and the second unique information input to the portable terminal 4, whether or not an association exists with the identification information.

According to this configuration, it is determined whether or not an association exists with the identification information, with the unique information based on both the first unique information acquired via communication and the second unique information input by a user of the portable terminal 4. Thus, security can be further improved. In addition, the second unique information is shown on the key medium 3, and thus it is possible to prevent an unauthorized use due to remote control because the user looks at and inputs the second unique information in person.

### INDUSTRIAL APPLICABILITY

The present disclosure is applicable in a key system that performs communication between each of a vehicle and a key unit and a portable terminal.

### REFERENCE SIGNS LIST

1: Key system, 2: Vehicle, 3: Key medium, 4: Portable terminal, 5: Portable terminal, 21: First storage part, 23: Common key information transmission part, 31: Second storage part, 44: Inter-portable transmission part, 221: First determination part, and 222: Second determination part

1. A key system comprising:
a first storage part provided in a vehicle and storing identification information with which the vehicle can be identified; and
a second storage part provided in a key medium and storing unique information associated with the identification information,
wherein
the vehicle is provided with a first determination part, a second determination part, and a common key information transmission part,
the first determination part is configured to determine whether or not an association exists between identification information stored in the first storage part and unique information stored in the second storage part,
in a case where the first determination part determines that the association exists, the second determination part determines whether or not an association exists between unique information, associated with the identification information and acquired by a portable terminal from the key medium, and the identification information stored in the first storage part, and
in a case where the second determination part determines that the association exists, the common key information transmission part transmits common key information allowing control of the vehicle to the portable terminal.

2. A key system comprising:
a first storage part provided in a vehicle and storing identification information with which the vehicle can be identified; and
a second storage part provided in a key medium and storing unique information associated with the identification information,
wherein
the vehicle is provided with a first determination part, a second determination part, and a common key information transmission part,
the first determination part is configured to determine whether or not an association exists between identification information stored in the first storage part and unique information stored in the second storage part,
in a case where the first determination part determines that the association exists, the second determination part determines whether or not an association exists between identification information, with which the vehicle can be identified, acquired by a portable terminal from the vehicle, and the identification information stored in the first storage part, and
in a case where the second determination part determines that the association exists, the common key information transmission part transmits common key information allowing control of the vehicle to the portable terminal.

3. The key system according to claim 2, wherein the key system is configured to perform communication between the key medium and the vehicle, and is configured such that the unique information stored in the key medium is read by the vehicle.

4. The key system according to claim 1, further comprising an inter-portable transmission part configured to allow the portable terminal to transmit, to another portable terminal different from the portable terminal, the common key information that has been transmitted.

5. The key system according to claim 1, wherein the common key information transmission part is configured to encrypt the common key information with a common encryption key preset between the vehicle and the portable terminal, and transmit the common key information to the portable terminal.

6. The key system according to claim 1, wherein the common key information transmission part is configured to transmit a plurality of pieces of the common key information to the portable terminal, and among the plurality of pieces of the common key information, one piece of the common key information to be transmitted first to the portable terminal is encrypted with a common encryption key preset between the vehicle and the portable terminal, and another piece of the common key information to be transmitted subsequently is encrypted based on one piece of the common key information transmitted immediately previously.

7. The key system according to claim 1, wherein
the unique information includes first unique information acquirable by the portable terminal via communication and second unique information shown on the key medium, and
the second determination part is configured to determine, based on the first unique information, and the second unique information input to the portable terminal, whether or not an association exists with the identification information.

8. The key system according to claim 2, further comprising an inter-portable transmission part configured to allow the portable terminal to transmit, to another portable terminal different from the portable terminal, the common key information that has been transmitted.

9. The key system according to claim 3, further comprising an inter-portable transmission part configured to allow the portable terminal to transmit, to another portable terminal different from the portable terminal, the common key information that has been transmitted.

10. The key system according to claim 2, wherein the common key information transmission part is configured to encrypt the common key information with a common encryption key preset between the vehicle and the portable terminal, and transmit the common key information to the portable terminal.

11. The key system according to claim 3, wherein the common key information transmission part is configured to encrypt the common key information with a common encryption key preset between the vehicle and the portable terminal, and transmit the common key information to the portable terminal.

12. The key system according to claim 2, wherein the common key information transmission part is configured to transmit a plurality of pieces of the common key information to the portable terminal, and among the plurality of pieces of the common key information, one piece of the common key information to be transmitted first to the portable terminal is encrypted with a common encryption key preset between the vehicle and the portable terminal, and another piece of the common key information to be transmitted subsequently is encrypted based on one piece of the common key information transmitted immediately previously.

13. The key system according to claim 3, wherein the common key information transmission part is configured to transmit a plurality of pieces of the common key information to the portable terminal, and among the plurality of pieces of the common key information, one piece of the common key information to be transmitted first to the portable terminal is encrypted with a common encryption key preset between the vehicle and the portable terminal, and another piece of the common key information to be transmitted subsequently is encrypted based on one piece of the common key information transmitted immediately previously.

14. The key system according to claim 2, wherein
the unique information includes first unique information acquirable by the portable terminal via communication and second unique information shown on the key medium, and
the second determination part is configured to determine, based on the first unique information, and the second unique information input to the portable terminal, whether or not an association exists with the identification information.

15. The key system according to claim 3, wherein
the unique information includes first unique information acquirable by the portable terminal via communication and second unique information shown on the key medium, and
the second determination part is configured to determine, based on the first unique information, and the second unique information input to the portable terminal, whether or not an association exists with the identification information.
